(19) United States
(12) Patent Application Publication
(10) Pub. No.: US 2026/0206007 A1
(43) Pub. Date: Jul. 16, 2026

(54) PROCESSING DEVICE, NETWORK NODE, AND CONTROL METHOD FOR FLEXIBLE OPERATION OF NETWORK SLICE

(71) Applicant: KDDI CORPORATION, Tokyo (JP)

(72) Inventors: Koji SAITO, Tokyo (JP); Yusuke NAKANO, Tokyo (JP)

(21) Appl. No.: 19/563,135

(22) Filed: Mar. 11, 2026

Related U.S. Application Data
(63) Continuation of application No. PCT/JP2024/032639, filed on Sep. 12, 2024.

(30) Foreign Application Priority Data
Sep. 26, 2023 (JP) 2023-163023

(51) Int. Cl. H04W 72/04

(52) U.S. Cl. CPC H04W 72/04

(57) ABSTRACT

A processing device that functions as an Application Function (AF) obtains identification information of a terminal device from the terminal device, transmits, to a network node in a core network of a cellular communication system, the identification information of the terminal device, an identifier of a first network slice assigned to communication executed by the terminal device, and specifying information specifying one or more second network slices requested to be assigned to the communication, and receives, from the network node, a response indicating whether a change in the network slice assigned to the communication from the first network slice to any of the one or more second network slices is allowed. The network slice assigned to the communication is changed in accordance with the change being allowed.

### CROSS-REFERENCE TO RELATED APPLICATIONS

This application is a continuation of International Patent Application No. PCT/JP2024/032639 filed on September 12, 2024, which claims priority to and the benefit of Japanese Patent Application No. 2023-163023, filed September 26, 2023, the entire disclosures of which are incorporated herein by reference.

### BACKGROUND OF THE INVENTION

### Field of the Invention

The present invention relates to techniques that enable flexible operation of network slices.

### Description of the Related Art

Known methods for using network slices include single slice, in which a single network slice is allocated to a terminal device, and multi-slice, in which a plurality of network slices for various applications or communication categories are allocated to a terminal device, for example. The UE Route Selection Policy (URSP) is also known as a mechanism that supports the use of network slices in accordance with communication categories associated with applications in multi-slice. The core network notifies a terminal device of URSP rules, and the terminal device can then select an appropriate network slice by verifying an explicit request from the application against the URSP rules.

When URSP is used, the network slice that is selected is intended only for communication by an application that supports the network slice selection mechanism and that has explicitly requested the use of that network slice. On the other hand, a default network slice can be assigned to communication by, for example, a terminal device that does not support the network slice selection mechanism and applications that do not explicitly request the use of a network slice. In other words, it is conceivable that appropriate network slice allocation cannot be performed for a particular terminal device or application.

### SUMMARY OF THE INVENTION

The present invention provides a technique that makes it possible to flexibly allocate network slices for communication by various applications and terminal devices.

A processing device according to one aspect of the present invention is a processing device that functions as an Application Function (AF), the processing device comprising: an obtaining unit configured to obtain identification information of a terminal device from the terminal device; a transmitting unit configured to transmit, to a network node in a core network of a cellular communication system, the identification information of the terminal device, an identifier of a first network slice assigned to communication executed by the terminal device, and specifying information specifying one or more second network slices requested to be assigned to the communication; and a receiving unit configured to receive, from the network node, a response indicating whether a change in the network slice assigned to the communication from the first network slice to any of the one or more second network slices is allowed, wherein the network slice assigned to the communication is changed in accordance with the change being allowed.

A network node according to one aspect of the present invention is a network node in a core network of a cellular communication system, the network node comprising: an obtaining unit configured to obtain, from an Application Function (AF), identification information of a terminal device, an identifier of a first network slice assigned to communication executed by the terminal device, and specifying information specifying one or more second network slices requested to be assigned to the communication; a determining unit configured to determine whether to allow a change in the network slice assigned to the communication from the first network slice to any of the one or more second network slices; a transmitting unit configured to transmit a response indicating a result of the determining to the AF; and an executing unit configured to execute processing for changing the network slice assigned to the communication in accordance with the change being allowed.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example of the configuration of a wireless communication system.

FIG. 2 is a diagram illustrating an example of the flow of processing when an AF requests a network slice change.

FIG. 3 is a diagram illustrating an example of the flow of processing when an AF requests a network slice change.

FIG. 4 is a diagram illustrating an example of the flow of processing for determining whether a network slice can be moved.

FIG. 5 is a diagram illustrating an example of the flow of processing for determining whether a network slice can be moved.

FIG. 6A is a diagram illustrating an example of the advance setting of a combination of a pre-movement slice and a post-movement slice.

FIG. 6B is a diagram illustrating an example of the advance setting of a combination of a pre-movement slice and a post-movement slice.

FIG. 7 is a diagram illustrating an example of the flow of processing when an AF requests a network slice change.

FIG. 8 is a diagram illustrating an example of the flow of processing when an AF requests a network slice change.

FIG. 9 is a diagram illustrating an example of the flow of processing when an AF requests a network slice change.

FIG. 10 is a diagram illustrating an example of the hardware configurations of a processing device and a network node.

FIG. 11 is a diagram illustrating an example of the functional configuration of a processing device.

FIG. 12 is a diagram illustrating an example of the functional configuration of a network node.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

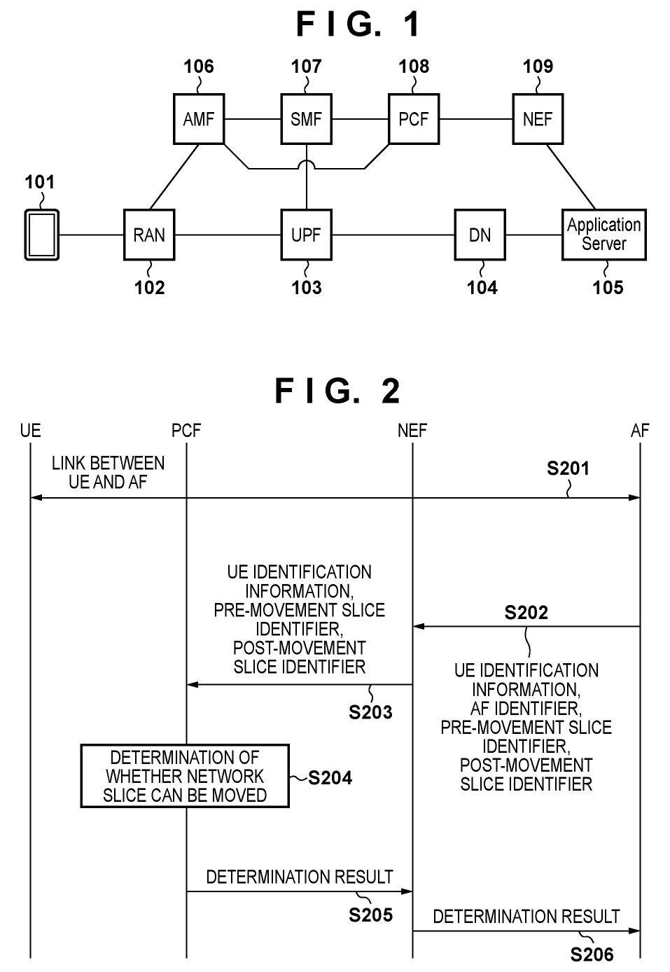

FIG. 1 illustrates an example of the configuration of a wireless communication system according to the present embodiment. The wireless communication system in FIG. 1 may be, for example, a wireless communication system compliant with the fifth-generation (5G) or subsequent cellular communication standard of the Third-Generation Partnership Project (3GPP (registered trademark)). The wireless communication system is configured to provide a wireless communication service to a terminal device (User Equipment), for example. The terminal device will be called a “UE 101” in the present embodiment. The UE 101 can communicate with an application server 105 via a RAN 102, a UPF 103, and a DN 104, for example. Here, “RAN” refers to “Radio Access Network”; “UPF”, to “User Plane Function”; and “DN”, to “Data Network”. The UPF 103 is a function of the core network of the cellular communication system, and the DN 104 is a network outside the core network. A gateway is present between the UPF 103 and the DN 104, but is not illustrated here. The core network further includes functions such as an AMF 106, an SMF 107, a PCF 108, an NEF 109, and the like. Here, “AMF” refers to “Access and Mobility Management Function”; “SMF”, to “Session Management Function”; “PCF”, to “Policy Control Function”; and “NEF”, to “Network Exposure Function”. Note that the core network includes other functions, but these are not illustrated here to simplify the descriptions. Each function in the core network can be implemented by a separate network node. However, the configuration is not limited thereto, and a plurality of functions may be aggregated and implemented in a single network node. The application server 105 can access the core network through the NEF 109. The application provided by the application server 105 is also called an Application Function (AF).

The UE 101 can support a UE Route Selection Policy (URSP), for example, and explicitly request the use of network slices in communication with the AF. For example, the URSP associates applications installed in the UE 101, the details of communication executed by the UE 101, and the like with network slices in advance, and during communication, the UE 101 requests the use of an explicit network slice in accordance with the executed application, the details of the communication and the like. For example, a video distribution application is associated with a video distribution slice in advance, and a game application is associated with a game slice in advance, and when the communication of those applications is executed, the use of the slices corresponding thereto is requested. Then, when the network side accepts the request, a network slice appropriate for the communication of that application is set. Meanwhile, a default network slice is set for communication that is different from the communication by those applications. The URSP settings are determined, for example, by the network operator, and the UE 101 is notified of the settings during initial registration of the UE 101, for example.

In this manner, the communication performed by the UE 101 can use the explicitly-requested network slice, using the URSP, for example, in accordance with the application, the details of the communication, and the like. On the other hand, at present, a network slice appropriate for the communication of the UE 101 will not be selected and assigned based on the initiative of the application server 105. In other words, for example, when the UE 101 does not support the slice selection mechanism according to the URSP, when the network slice corresponding to the executed application is not defined in advance, or the like, the default network slice will be assigned even if a more appropriate network slice for that communication is available. Additionally, the user cannot be offered a higher quality communication environment while communication for a predetermined application is underway, for example.

In light of such a situation, the present embodiment provides a procedure that makes it possible to set a network slice to be assigned to the communication of the UE 101 based on the initiative of the application server 105. The application server 105 will be called “AF” hereinafter.

### Flow of Processing

In the present embodiment, for example, the AF requests a network node, such as the PCF 108 or the AMF 106, to change the network slice assigned to the communication of the UE through the NEF 109. For example, the AF transmits, to the network node, a request including the identification information of the UE, an identifier of a first network slice from before the change in the communication of the UE (a pre-movement slice), and specifying information specifying one or more candidates for a second network slice to be used by the UE after the change (a post-movement slice). Then, in accordance with the network node allowing the network slice to be changed, the network slice is switched by changing the session according to the procedure described in Section 4.3.3.2 of 3GPP TS 23.502 V18.3.0, for example. This makes it possible to set a network slice suitable for the communication by the UE 101 in response to the AF request. In other words, for example, for communication by an application not defined by the URSP policy, when the UE 101 does not support the slice selection mechanism, and the like, a network slice suitable for the communication by that application can be set by specifying a network slice suitable for the application in advance on the AF side. Note that the network node that receives the request does not absolutely have to accept the request, and may reject the request depending on the circumstances.

FIG. 2 illustrates an example of the flow of processing when the AF requests a network slice change according to the present embodiment. For example, the AF starts a link by the UE 101 executing a predetermined application, and obtains identification information of the UE 101 (S201). Here, the identification information of the UE 101 is, for example, a combination of the Internet Protocol (IP) address of the UE 101, a Data Network Name (DNN), and Single-Network Slice Selection Assistance Information (S-NSSAI). In other words, the AF can obtain information specific to the session established for the communication by the application of the UE 101 as the identification information of the UE 101. Alternatively, the identification information of the UE 101 may be a User Equipment Identifier (UE ID). In this case, although the UE 101 is specified, the session itself is not distinguished. For example, the AF determines whether the network slice used in the communication with the UE 101 is a network slice not suitable for the application to be executed with the UE 101 (e.g., the default network slice). Note that when an application not defined by the URSP policy is provided or the like, the default network slice is assigned to all the communication by that application, and thus the following processing may be executed by the AF under the assumption that it is always necessary to change the network slice.

When a network slice change is necessary, the AF transmits information indicating a request to change the network slice to the NEF 109 (step S202). At this point in time, no interface for transmitting such information exists, and thus a newly-defined interface is used to transmit the information. This information includes, for example, the identification information of the UE 101 obtained in S201, the identifier of the pre-movement network slice, and the identifier of the post-movement network slice. Note that the identification information of the UE 101 may be a combination of the IP address of the UE 101, the DNN, and the S-NSSAI, or may be a UE ID, as described above. Additionally, “pre-movement network slice” indicates the network slice assigned to the communication by the UE 101. Note that as recognized by the AF, the pre-movement network slice does not necessarily match the network slice assigned when the information in S202 is actually transmitted. “Post-movement network slice” indicates a candidate for the network slice requested to be assigned to the communication by the UE 101. Note that there need not be only one candidate for the post-movement network slice, and a plurality of candidates may be present. In other words, the AF may transmit the identifiers of a plurality of network slices to the NEF 109 as the identifiers of post-movement network slices. The AF can also transmit identification information identifying itself to the NEF 109. This is used when the result of determining whether the network slice can be moved thereafter is communicated to the AF from the NEF 109 or the like. However, if the AF is uniquely specified through some kind of procedure, the explicit transmission of the identifier of the AF may be omitted.

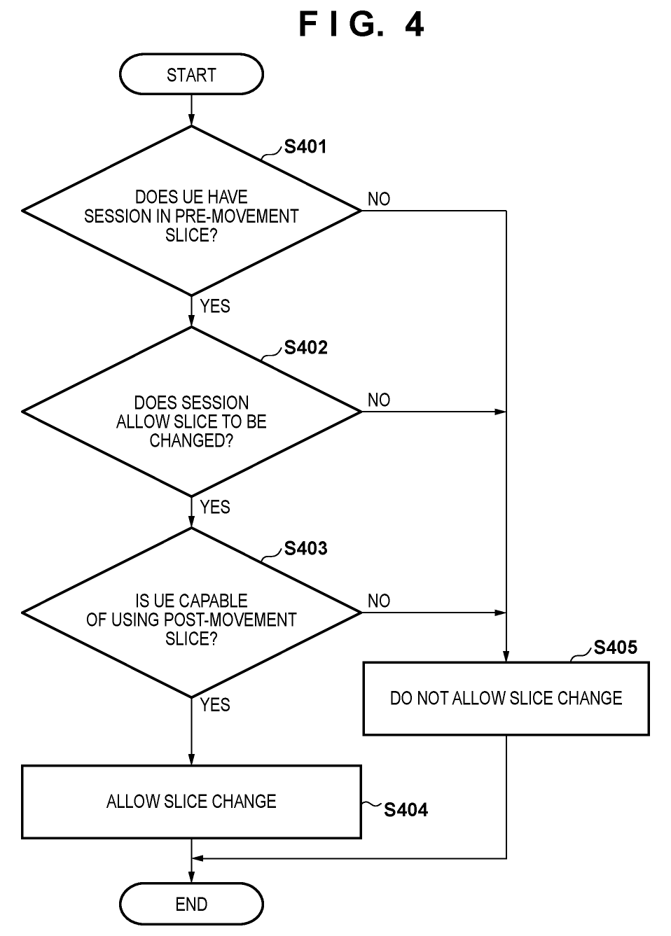

The NEF 109 transfers the received information to the PCF 108 (S203). Note that if the NEF 109 receives the identifier of the AF, that identifier need not be transferred to the PCF 108. However, this is merely one example, and the NEF 109 may transfer the identifier of the AF to the PCF 108 as well. At this point in time, no interface for transferring the information exists, and thus a newly-defined interface is used to transmit this information. Upon receiving this information, the PCF 108 determines whether to allow the network slice assigned to the communication by the UE 101 to be changed (S204). The PCF 108 then notifies the AF of the result of the determination via the NEF 109 (S205, S206). In this determination, if the network slice is allowed to be changed, the network slice is switched by changing the session according to the procedure described in Section 4.3.3.2 of TS 23.502, for example. For example, the PCF 108 changes the existing session to a session corresponding to the post-change network slice by starting the processing according to the procedure of step 1b indicated in FIG. 4.3.3.2-1 in Section 4.3.3.2 of TS 23.502.

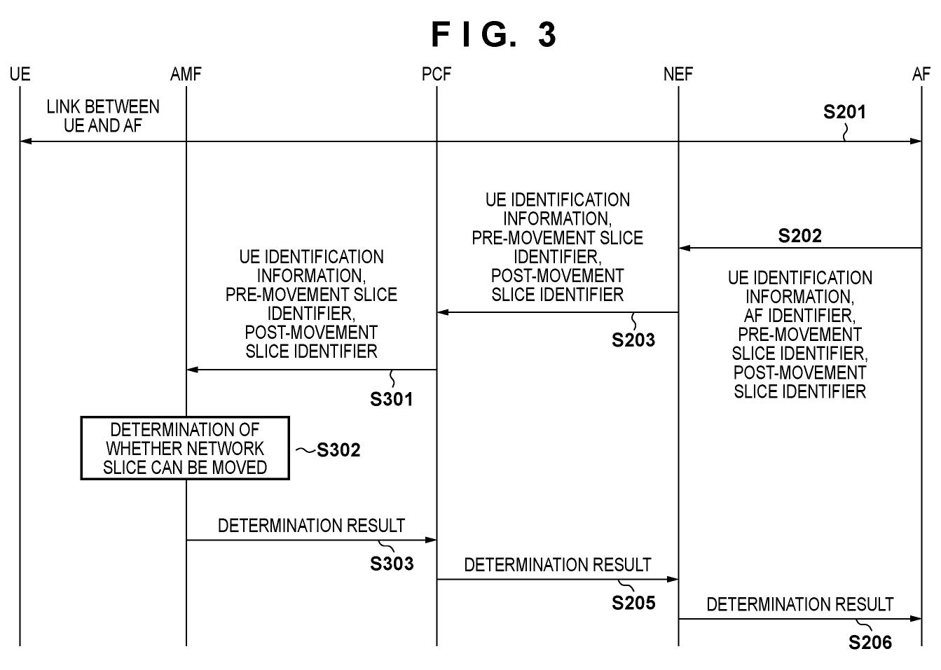

Although FIG. 2 illustrates an example in which the PCF 108 determines whether the network slice can be changed, this determination may be executed by another function, such as the AMF 106, for example. FIG. 3 illustrates an example of the flow of processing when the AMF 106 makes this determination. In the processing in FIG. 3, the PCF 108 transferring the received information to the AMF 106 (S301), the AMF 106 determining whether the network slice can be changed based on that information (S302), and transmitting the result to the AF via the PCF 108, for example (S303), are different from the processing in FIG. 2. In this manner, whether the network slice can be changed may be determined by the PCF 108, or by the AMF 106. Additionally, this determination may be made by yet another function, or a new function for making the determination may be defined. In this case too, if the network slice is allowed to be changed, the network slice is changed by changing the session according to the procedure described in Section 4.3.3.2 of TS 23.502, for example. For example, the AMF 106 changes the existing session to a session corresponding to the post-change network slice by starting the processing according to the procedure of step 1h indicated in FIG. 4.3.3.2-1 in Section 4.3.3.2 of TS 23.502.

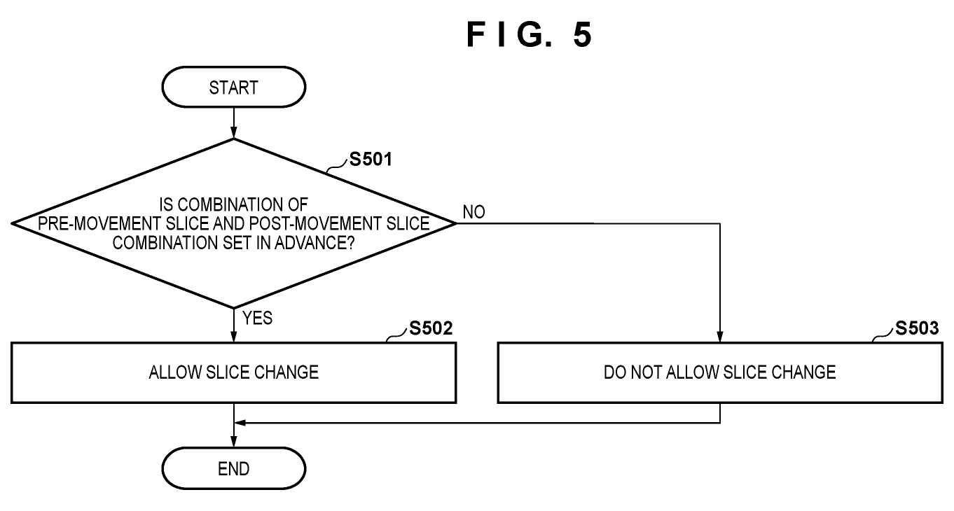

An example of the above-described procedure for determining whether to change the network slice will be described next with reference to FIGS. 4 and 5. This processing is executed, for example, by a network node that implements the PCF 108 or the AMF 106.

In FIG. 4, the network node first determines whether the UE 101 has a session in the pre-movement network slice (S401). In other words, the network node determines whether the network slice communicated as the pre-movement network slice is associated with the session for the communication by the UE 101. Additionally, if the identification information of the UE 101 is a combination of an IP address, a DNN, and S-NSSAI, whether a session uniquely identified by that combination is present can be determined, and whether the pre-movement network slice has been assigned to that session can be determined as well. Note that if the identification information of the UE 101 is a combination of an IP address, a DNN, and S-NSSAI, even if multiple sessions are assigned to the same network slice, whether any of those sessions is the subject of the network slice change request can be identified. However, if the UE 101 is determined to have a session in the pre-movement network slice (YES in S401), the network node then determines whether the session allows the network slice to be changed (S402). In other words, whether the session is configured to not allow the network slice to be changed is confirmed. For example, a voice call session is configured not to allow the network slice to be changed, and the determination can be made to prevent the network slice of such a session from being changed. If the network node determines that the session of the UE 101 allows the network slice to be changed (YES in S402), the network node determines whether the UE 101 is capable of using the network slice designated as the post-movement network slice (S403). If it is determined that the UE 101 is capable of using the network slice designated as the post-movement network slice (YES in S403), the network node determines to allow the network slice for the communication by the UE 101 to be changed (S404). On the other hand, if it is determined that the UE 101 does not have a session in the pre-movement network slice (NO in S401), if it is determined that the session does not allow the network slice to be changed (NO in S402), or if the UE 101 is not capable of using the network slice designated as the post-movement network slice (NO in S403), the network node determines not to allow the network slice for the communication by the UE 101 to be changed (S405).

Note that a setting can be made in which when, for example, a Protocol Data Unit (PDU) session is established, whether the session will accept a network slice change at the initiative of the network side (e.g., the AF) is determined. A value (flag) indicating this setting can be held in the PCF 108, for example. The determination in S402 described above may be made based on this setting. In this case, when the AMF 106 executes the determination processing, the AMF 106 can query the PCF 108 for the setting information held therein. Additionally, even if the AMF 106 executes the determination processing, the determination in S402 may be executed by the PCF 108. In this case, if it is determined in the PCF 108 that the session does not allow the network slice to be changed, the AMF 106 may not be notified of the information (S301), the PCF 108 may determine not to allow the change, and the AF may be notified of the determination result via the NEF 109. On the other hand, if the PCF 108 determines that the session allows the network slice to be changed, the PCF 108 can perform the information notification in S301. In this case, the AMF 106 may omit the determination in S402. Because the AMF 106 is notified of the information in S301, the session can be identified as allowing the network slice to be changed, and the AMF 106 does not need to make the determination. The PCF 108 may explicitly notify the AMF 106 of the result of the determination, or may implicitly notify the AMF 106 based on whether the information notification in S301 is made. The determination as to whether the UE 101 has a session in the pre-movement network slice (S401) may also be made in the PCF 108. Note that these are merely examples, and for example, a value indicating the setting as to whether the session accepts a change in the network slice may be held in a function different from the PCF 108. The allotment of the determination processing between the AMF 106 and the PCF 108 may also be changed through another format.

Note that the determination in FIG. 4 is merely an example, and determinations that are based on additional conditions, in addition to the stated determination criteria, may also be made. In other words, the network node may allow the network slice to be changed under the sole condition that the UE 101 has a session in the pre-movement network slice, the session allows the network slice to be changed, and the UE 101 is capable of using the post-movement network slice, or additional conditions may be required for the network slice to be changed.

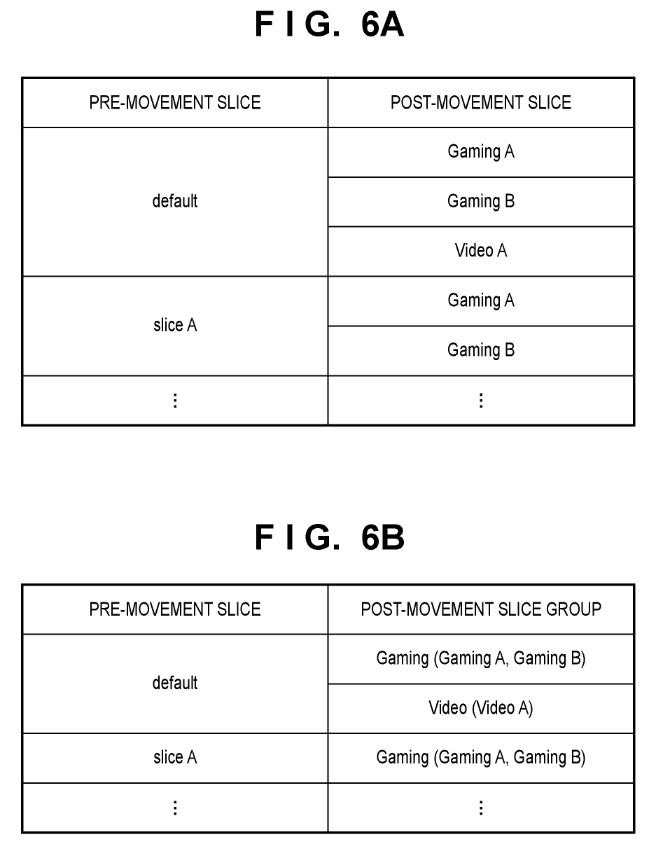

FIG. 5 illustrates an example of the flow of other determination processing. Note that the determination processing in FIG. 5 may be used in conjunction with the determination processing in FIG. 4. In other words, if, in the determination processing in FIG. 4, it is determined that the UE 101 is capable of using the network slice designated as the post-movement network slice (YES in S403), the determination processing in FIG. 5 may be executed without advancing the sequence to S404. It is also possible to perform only the determination processing in FIG. 5. In FIG. 5, the network node determines whether the combination of the pre-movement network slice and the post-movement network slice is a combination set in advance (S501). Then, the network node only allows the change (S502) for the combination set in advance (YES in S501), and does not allow the change (S503) for other combinations (NO in S501). FIG. 6A illustrates an example of the advance setting of the combination. For example, in FIG. 6A, if the pre-movement network slice is the default network slice, only “Gaming A”, “Gaming B”, and “Video A” are allowed as post-movement network slices. In addition, if the pre-movement network slice is “Slice A”, only “Gaming A” and “Gaming B” are allowed as post-movement network slices. As an example, if the pre-movement network slice is “Slice A” and the post-movement network slice is designated as “Video A”, the network node rejects the change in the network slice. However, if, for example, the pre-movement network slice is the default network slice and the post-movement network slice is designated as “Video A”, the network node permits the change in the network slice. Note that the network node may make a determination that is based on additional conditions, in addition to the determination in FIG. 5.

In the determination processing in FIGS. 4 and 5, if, for example, a plurality of candidates for the post-movement network slice are present, it can be determined that the network slice can be changed when a change to any one of those candidates is allowed. For example, in the determination in S403, the network node determines whether the UE 101 is capable of using any of a plurality of candidates for the post-movement network slice. The network node may then determine to allow the slice to be changed if the UE 101 is capable of using any one of the plurality of candidates for the post-movement network slice. However, the network node may determine not to allow the slice to be changed if the UE 101 is not capable of using any of the plurality of candidates for the post-movement network slice. In addition, in the determination in S501, the network node can determine whether each of combinations of the pre-movement network slice and the plurality of candidates for the post-movement network slice is a combination set in advance. The network node may then determine to allow the slice to be changed if any one of the combinations of the pre-movement network slice and the plurality of candidates for the post-movement network slice is a combination set in advance. However, the network node may determine not to allow the slice to be changed if not all combinations of the pre-movement network slice and the plurality of candidates for the post-movement network slice are combinations set in advance.

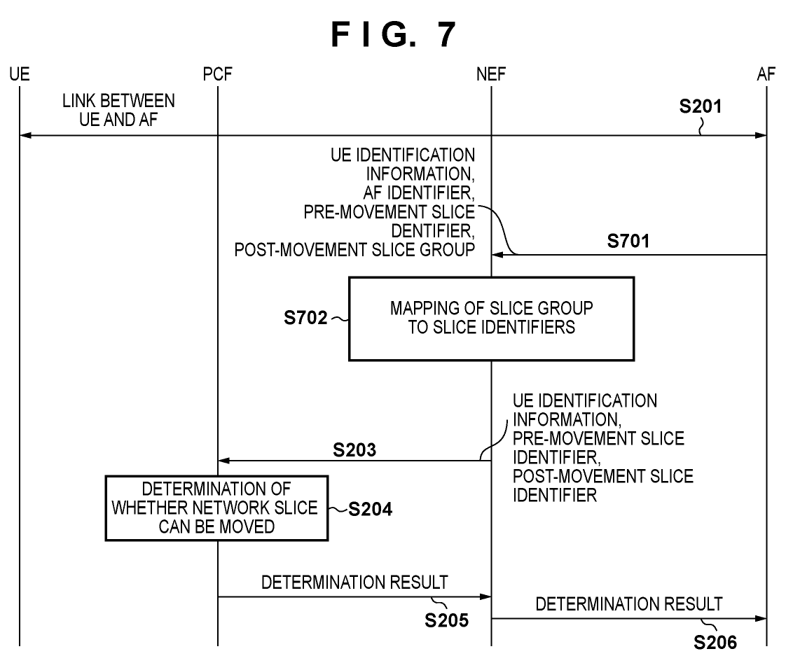

Although the foregoing has described an example of a flow of processing when the AF communicates the identifier of one or more candidates for the post-movement network slice, the AF may transmit a group of post-movement network slices corresponding to a plurality of candidates for the post-movement network slice to the NEF 109. FIG. 7 illustrates an example of the flow of processing in that case. Instead of the identifier of the post-movement network slice, the AF transmits information indicating a group of post-movement network slices to the NEF 109 (S701). Upon receiving the information indicating the group of the network slices, the NEF 109 maps that group to network slice identifiers (S702). In other words, the NEF 109 holds information associating the group with network slice identifiers, and specifies the identifier of the corresponding network slice from the information of the group. Note that the NEF 109 may specify an identifier for one network slice among the network slices included in the group, or may specify identifiers for all of the network slices included in the group. The NEF 109 can then convert the information of the group into network slice identifiers and transfer the information from the AF to the PCF 108 (S702). The subsequent processing can be performed in the same manner as in FIGS. 2 and 3, for example.

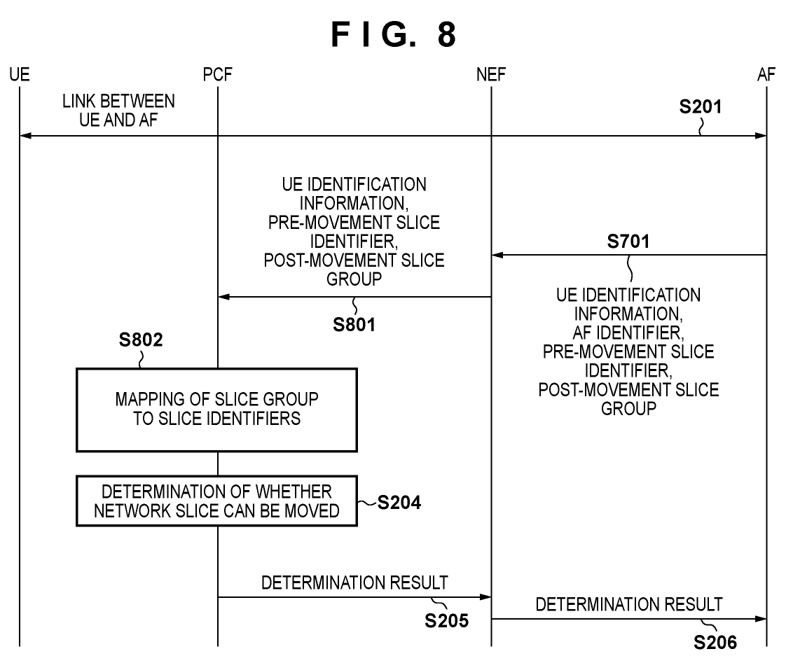

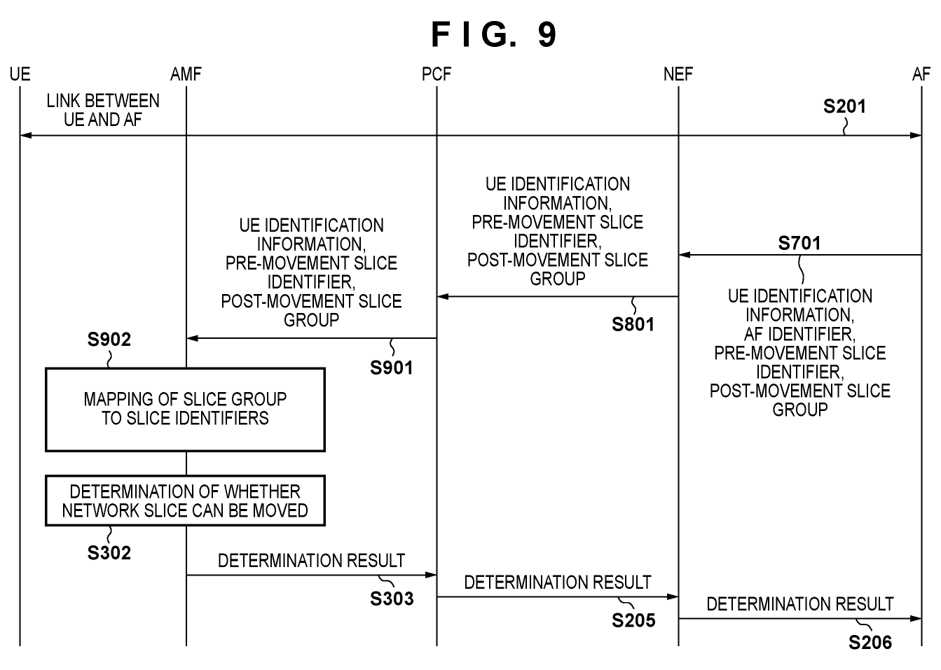

Note that the mapping of the group to the network slice identifiers may be executed by a function different from the NEF 109. For example, as illustrated in FIG. 8, this mapping may be performed in the PCF 108 (S802). In this case, the information of the group received from the AF can be transferred from the NEF 109 to the PCF 108 as-is (S801). As illustrated in FIG. 9, this mapping may be performed in the AMF 106 (S902). In this case, the information of the group received from the AF can also be transferred from the PCF 108 to the AMF 106 as-is (S901). Note that the group may include only one candidate for the post-movement network slice, or may include two or more candidates for the post-movement network slice. If a plurality of candidates for the post-movement network slice are included in the group, it can be determined, in the determination processing in FIGS. 4 and 5, that the network slice can be changed when a change to any one of those candidates is allowed, as described above. Note that whether the pre-movement network slice and the post-movement network slice group are a combination set in advance may be determined in the determination processing in FIG. 5. In this case, for example, the pre-movement network slice and a group including one or more candidates for the post-movement network slice are associated in the advance setting, as illustrated in FIG. 6B. When this processing is performed, the above-described mapping need not be performed, and processing may be performed such that after determining that the network slice is allowed to be changed, the post-change network slice is selected from within the group.

As described above, the network slice can be changed based on the initiative by the AF. Through this, even if an application is of a type not defined in advance in the URSP policy, for example, a network slice suited to that application can be assigned to the communication by that application. For example, while the UE 101 is communicating in a predetermined network slice corresponding to a predetermined application, an offer to use a network slice corresponding to a higher-quality environment can be made, for example. In this case, for example, the user of the UE 101 can be presented with an indication that a high-quality network slice can be used for an additional fee or the like, and the AF can request a change in the network slice when the user approves.

### Device Configuration

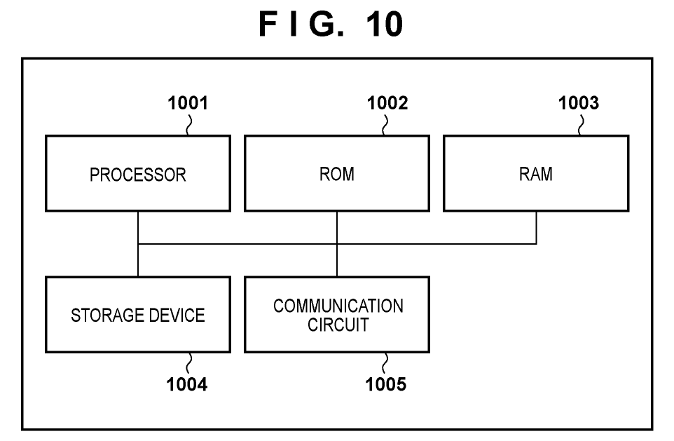

FIG. 10 illustrates an example of the hardware configuration of a processing device that requests a network slice change (e.g., that functions as the AF) and a network node that handles the request (e.g., that functions as the PCF 108 or the AMF 106). In one example, the processing device and the network node are configured including a processor 1001, a ROM 1002, a RAM 1003, a storage device 1004, and a communication circuit 1005. The processor 1001 is a computer configured including at least one processing circuit such as a general-purpose Central Processing Unit (CPU), an Application-Specific Integrated Circuit (ASIC), or the like, and executes overall processing of the device, the individual processes described above, and the like by reading out programs stored in the ROM 1002, the storage device 1004, and the like and executing the programs. The ROM 1002 is a read-only memory that stores programs, information such as various parameters, and the like pertaining to the processing executed by the processing device and the network node. The RAM 1003 functions as a work space when the processor 1001 executes programs, and is a random access memory that stores temporary information. The storage device 1004 is constituted by, for example, a removable external storage device or the like. The communication circuit 1005 is constituted by circuitry capable of communicating in the 5G core or a core network in a successor standard thereof, for example. Although one communication circuit 1005 is illustrated in FIG. 10, the processing device and the network node can each have a plurality of communication circuits.

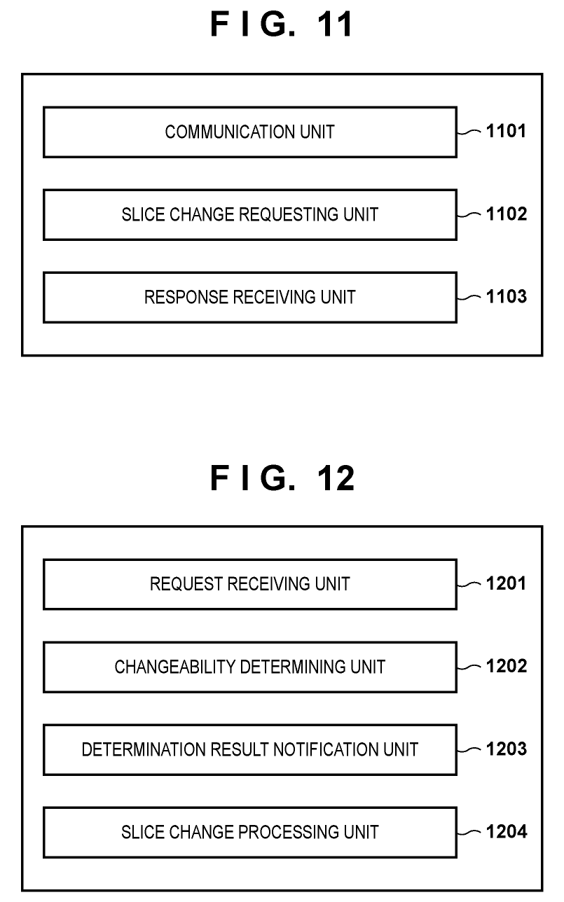

FIG. 11 is a diagram illustrating an example of the functional configuration of the processing device (e.g., that functions as the AF). The processing device includes, for example, a communication unit 1101, a slice change requesting unit 1102, and a response receiving unit 1103. Note that these functions can be implemented by the processor 1001 executing programs stored in the ROM 1002, the storage device 1004, or the like, for example. However, this is only one example, and the functions in FIG. 11 may be implemented by other configurations. Additionally, the functions illustrated in FIG. 11 are merely examples, and the various types of control processing described above may be implemented by other function units as well. Note that the specific operations of each of the function units are as described above, and thus descriptions thereof will be omitted, with only the general functional configuration being described here.

The communication unit 1101 communicates with the UE 101 via the RAN 102, the UPF 103, and the DN 104, for example. The communication unit 1101 transmits and receives application data through communication with the UE 101. Additionally, the communication unit 1101 can obtain identification information of the UE 101 (e.g., a combination of an IP address, a DNN, and S-NSSAI, or a UE ID), for example, through communication with the UE 101. The slice change requesting unit 1102 transmits information including the identification information of the UE 101, the identifier of the pre-movement network slice, and specifying information specifying one or more candidates for the post-movement network slice (e.g., information indicating identifiers or a group of the one or more candidates) to the NEF 109, and requests a change in the network slice assigned to the communication by the UE 101. The response receiving unit 1103 receives, from the NEF 109, a response including a result of the determination as to whether the request by the slice change requesting unit 1102 has been allowed.

FIG. 12 is a diagram illustrating an example of the functional configuration of the network node (e.g., that functions as the PCF 108 or the AMF 106). The network node includes, for example, a request receiving unit 1201, a changeability determining unit 1202, a determination result notification unit 1203, and a slice change processing unit 1204. Note that these functions can be implemented by the processor 1001 executing programs stored in the ROM 1002, the storage device 1004, or the like, for example. However, this is only one example, and the functions in FIG. 12 may be implemented by other configurations. Additionally, the functions illustrated in FIG. 12 are merely examples, and the various types of control processing described above may be implemented by other function units as well. Note that the specific operations of each of the function units are as described above, and thus descriptions thereof will be omitted, with only the general functional configuration being described here.

The request receiving unit 1201 receives a request to change the network slice assigned to the communication by the UE 101 from the processing device (which functions as the AF) through the NEF 109. The changeability determining unit 1202 determines whether to allow the network slice assigned to the communication by the UE 101 to be changed based on the information included in the change request. Through the NEF 109, the determination result notification unit 1203 notifies the processing device of the result of the determination by the changeability determining unit 1202, in the form of a response signal responding to a request signal, for example. When the network slice assigned to the communication by the UE 101 is allowed to be changed, the slice change processing unit 1204 executes processing for changing the network slice. The slice change processing unit 1204 can change the network slice according to the session modification procedure specified in Section 4.3.3.2 of TS 23.502, for example.

According to the present invention, network slices can be flexibly allocated for communication by various applications and terminal devices.

As described above, according to the present embodiment, a network slice can be changed at the initiative of an AF. Through this, even if an application is of a type not defined in advance in the URSP policy, for example, a network slice suited to that application can be assigned to the communication by that application. This makes it possible to contribute to Goal 9 of the United Nations-led Sustainable Development Goals (SDGs), which is to “build resilient infrastructure, promote inclusive and sustainable industrialization, and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A processing device that functions as an Application Function (AF), the processing device comprising:
an obtaining unit configured to obtain identification information of a terminal device from the terminal device;
a transmitting unit configured to transmit, to a network node in a core network of a cellular communication system, the identification information of the terminal device, an identifier of a first network slice assigned to communication executed by the terminal device, and specifying information specifying one or more second network slices requested to be assigned to the communication; and
a receiving unit configured to receive, from the network node, a response indicating whether a change in the network slice assigned to the communication from the first network slice to any of the one or more second network slices is allowed,
wherein the network slice assigned to the communication is changed in accordance with the change being allowed.

2. The processing device according to claim 1,
wherein the identification information of the terminal device is a combination of an Internet Protocol (IP) address of the terminal device, a Data Network Name (DNN), and Single-Network Slice Selection Assistance Information (S-NSSAI).

3. The processing device according to claim 1,
wherein the identification information of the terminal device is a User Equipment Identifier (UE ID).

4. The processing device according to claim 1,
wherein the specifying information is information indicating a group of the one or more second network slices.

5. The processing device according to claim 1,
wherein the specifying information is an identifier of each of the one or more second network slices.

6. A network node in a core network of a cellular communication system, the network node comprising:
an obtaining unit configured to obtain, from an Application Function (AF), identification information of a terminal device, an identifier of a first network slice assigned to communication executed by the terminal device, and specifying information specifying one or more second network slices requested to be assigned to the communication;
a determining unit configured to determine whether to allow a change in the network slice assigned to the communication from the first network slice to any of the one or more second network slices;
a transmitting unit configured to transmit a response indicating a result of the determining to the AF; and
an executing unit configured to execute processing for changing the network slice assigned to the communication in accordance with the change being allowed.

7. The network node according to claim 6,
wherein the network node is a Policy Control Function (PCF),
the obtaining unit obtains information from the AF via a Network Exposure Function (NEF), and
the transmitting unit transmits the response to the AF via the NEF.

8. The network node according to claim 6,
wherein the network node is an Access and Mobility Management Function (AMF),
the obtaining unit obtains information from the AF via a Network Exposure Function (NEF) and a Policy Control Function (PCF), and
the transmitting unit transmits the response to the AF via the PCF and the NEF.

9. The network node according to claim 6,
wherein the identification information of the terminal device is a combination of an Internet Protocol (IP) address of the terminal device, a Data Network Name (DNN), and Single-Network Slice Selection Assistance Information (S-NSSAI).

10. The network node according to claim 6,
wherein the identification information of the terminal device is a User Equipment Identifier (UE ID).

11. The network node according to claim 6,
wherein the determining unit determines to allow the change under a condition that the terminal device has a session on the first network slice, the session allows the change in the network slice, and any of the one or more second network slices is available.

12. The network node according to claim 6,
wherein the specifying information is information indicating a group of the one or more second network slices, and
the determining unit determines not to allow the change in a case where a combination of the identifier of the first network slice and the group of the one or more second network slices is not a combination set in advance.

13. The network node according to claim 6,
wherein the specifying information is information indicating an identifier of each of the one or more second network slices, and
the determining unit determines not to allow the change in a case where no combination of the identifier of the first network slice and any of the one or more second network slices is a combination set in advance.

14. A control method executed by a processing device that functions as an Application Function (AF), the control method comprising:
obtaining identification information of a terminal device from the terminal device;
transmitting, to a network node in a core network of a cellular communication system, the identification information of the terminal device, an identifier of a first network slice assigned to communication executed by the terminal device, and specifying information specifying one or more second network slices requested to be assigned to the communication; and
receiving, from the network node, a response indicating whether a change in the network slice assigned to the communication from the first network slice to any of the one or more second network slices is allowed,
wherein the network slice assigned to the communication is changed in accordance with the change being allowed.

15. A control method executed by a network node in a core network of a cellular communication system, the control method comprising:
obtaining, from an Application Function (AF), identification information of a terminal device, an identifier of a first network slice assigned to communication executed by the terminal device, and specifying information specifying one or more second network slices requested to be assigned to the communication;
determining whether to allow a change in the network slice assigned to the communication from the first network slice to any of the one or more second network slices;
transmitting a response indicating a result of the determining to the AF; and
executing processing for changing the network slice assigned to the communication in accordance with the change being allowed.
